(19) United States
(12) Patent Application Publication
(10) Pub. No.: US 2019/0188908 A1
(43) Pub. Date: Jun. 20, 2019

(54) METHOD AND SYSTEM FOR CONVERTING CONTENT FROM TWO-DIMENSIONS TO THREE-DIMENSIONS

(71) Applicant: Robert Alexander, Folsom, CA (US)

(72) Inventor: Robert Alexander, Folsom, CA (US)

(21) Appl. No.: 16/226,581

(22) Filed: Dec. 19, 2018

Related U.S. Application Data
(60) Provisional application No. 62/608,010, filed on Dec. 20, 2017.

(51) Int. Cl. G06T 17/10; G06F 17/50; G06F 3/0482

(52) U.S. Cl. CPC G06T 17/10; G06F 3/0482; G06F 17/5018

(57) ABSTRACT

Disclosed is a method and a system to convert two-dimensional (“2D”) content into three-dimensional (“3D”) content. The method includes receiving the 2D content and analyzing the 2D content to obtain a first set of data related to the 2D content. Further, the method includes determining a 2D-to-3D content conversion logic based on a result of the content analysis. Further, the method includes generating the 3D content by applying the determined logic to the received 2D content. Further, the method includes providing the generated 3D content. The 2D content includes at least one of an image, a Computer Aided Design (CAD) drawing, and a web image content. The first set of data includes vector parameters of one or more objects present in the content, text related to the one or more objects present in the content, dimensional data of the one or more objects present in the content.

### CROSS-REFERENCE TO RELATED PATENT DOCUMENTS

This patent application claims the benefit of priority of U.S. Provisional Application No. 62/608,010, entitled “method for converting content from two-dimensions to three-dimensions,” filed Dec. 20, 2017, which are hereby incorporated herein by reference in its entirety.

### FIELD OF THE INVENTION

The present invention relates generally to image conversion, and, more particularly, to a system and a method for converting content from a two-dimensional image into a three-dimensional image.

### BACKGROUND

In any industry, it is very important for industry professionals to locate relevant information for one or more industry sectors. Currently, industry professionals constantly face various problems and end up spending enormous amount of time, energy, and resources in locating the relevant information for the one or more industry sectors. Specifically, in construction industry, various stakeholders need to keep a regular track of information across multiple sources, such as websites, blogs, news portals, brick and mortar stores, local industry events and promotions, technical product literature, and the like.

Subsequently, it is crucial for construction industry professionals to ensure that they are aware about latest developments to learn about new products and methods. At the same time, it is desirable to efficiently obtain such information from the relevant sources so that smart business decisions can be taken promptly.

Generally, the industry professionals rely on various 2D (2-dimensional) drawings available across these multiple sources to locate the relevant information. However, the 2D drawings may not be sufficient to extract all of the relevant information, specifically, in the field of construction industry. When developing a 2D drawing, designers must visualize in their minds the structure they are trying to propose, and communicate the features and components of the structure to a fellow designer through a series of plans, elevations, side views, or planes in non-orthogonal view.

In 2D drawings, various views such as a plan view, an elevation view, and a side view are drawn on the same plane. In other words, regardless of whether the view direction chosen describes the plan view, the elevation view, or the side view, they are all described in the X- and -Y-axis plane of the 2D drawing. When these individual views are drawn in an XY plane, the relationship of each drawing with respect to the other drawings, as well as the location of the defined 2D objects in 3D (3-dimensional) space are completely lost. Substantial human effort is required to convert the individual drawings into a uniform 3D context to allow generation of a 3D model. Currently, applications allowing the generation of the 3D model from the 2D drawings with minimal human intervention are not commercially available.

Hence, there is a need of a system and a method for converting content from 2D to 3D with minimal human intervention for ease of dealing with various workload that users have to undertake such as tiling work, plumbing work, and so on in the construction trades.

### BRIEF SUMMARY

It will be understood that the current disclosure is not limited to the particular systems, and methodologies described, as there can be multiple possible embodiments of the present disclosure which are not expressly illustrated in the present disclosure. It is also to be understood that the terminology used in the description is for the purpose of describing the particular versions or embodiments only, and is not intended to limit the scope of the present disclosure.

It is an objective of the present invention to provide a method and a system for converting content from one or more 2D (two-dimensional) images into one or more 3D (three-dimensional) images. More specifically, it is an objective of the present invention to provide a system and a method to convert dull, flat, 2D images into rich, vibrant, information loaded 3D images.

It is another objective of the present invention to provide a system and a method for providing 3D images with installation specifications that eventually reduces human effort for reading the installation specifications.

In an embodiment, the present invention discloses a system and a method to convert 2D content into 3D content. The method includes one or more operations that are executed by circuitry of the system to convert the 2D content into the 3D content. For example, the method includes receiving the 2D content, for example, a 2D image. Further, the method includes analyzing the 2D content to obtain a first set of data related to the 2D content. Further, the method includes determining a 2D-to-3D content conversion logic based on a result of the content analysis. Further, the method includes generating a 3D image including the 3D content by applying the determined logic to the received 2D image. Further, the method includes providing the generated 3D content.

In an embodiment, the 2D content includes at least one of an image, a Computer Aided Design (CAD) drawing, and a web image content.

In an embodiment, the first set of data related to the 2D content includes one or more vector parameters of one or more objects present in the 2D content, text related to the one or more objects present in the 2D content, dimensional data of the one or more objects present in the 2D content.

In an embodiment, the present invention discloses a user interface that facilitates a user to search, and select 3D image files related to installation methods. The installation methods may be obtained from a variety of industry professionals associated with an industry such as a construction industry. The user interface is configured to receive, from one or more sources, a specification for a construction item made up of constituent elements in a 2D image file. For example, the user interface is configured to receive the 2D image file including the specification such as materials required (i.e., ceramic tiles, coated glass mat, wood studs, and the like), dimensions of the materials, and quantity of the materials that are essential for the construction item or application. After receiving the 2D image file, the 2D image file is processed and converted into one or more 3D image files. The user can utilize the user interface to search the desired 3D image file by providing one or more user preferences by means of various filter options that are available on the user interface. Thereafter, the user can select and view the desired 3D image file from the one or more 3D image files on the user interface.

In an embodiment, the user interface is further configured to receive a user request for the construction item or application that is made up of the constituent elements. In an embodiment, the user interface is further configured to generate a 3D image file based on the 2D image file and the user request. Thus, by converting dull, flat, 2D images into rich, vibrant, information loaded 3D imagery, the user interface offers better industry product understanding. In use, the user interface allows users to view multiple images of a product category having the same view of different products, thereby reducing the time spent for learning by approximately 60,000 times. Additionally, the multiple images, as disclosed herein, also provide additional information to users, such as, for example, but not limited to, installation specifications, thereby reducing the reading time by hours as compared to conventional approach of reading from a technical installation literature. Therefore, various embodiments of the present invention enable the users to learn about 100s and 1000s of new methods, products, and developments across various industry such as the construction industry. Particularly, such images may be employed along with text and/or links, wherein image with text explains the specifications on how to install that method and/or product.

These and other features and advantages along with other embodiments of the present invention will become apparent from the detailed description below, in light of the accompanying drawings.

### BRIEF DESCRIPTION OF THE ACCOMPANYING DRAWINGS

The novel features which are believed to be characteristic of the present disclosure, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this disclosure will now be described by way of example in association with the accompanying drawings in which:

FIG. 1 illustrates a system for converting a two-dimensional (“2D”) content into three-dimensional (“3D”) content, according to an exemplary embodiment of the present invention;

FIG. 2 illustrates an exemplary user interface of the system that facilitates a user to search a three-dimensional (“3D”) content corresponding to a two-dimensional (“2D”) content based on one or more user preferences selected by the user, according to an exemplary embodiment of the present invention;

FIGS. 3a-3c illustrates an exemplary scenario where a two-dimensional (“2D”) content is converted to a three-dimensional (“3D”) content, according to an exemplary embodiment of the present invention;

FIG. 3d illustrates an exemplary user interface displaying a converted three-dimensional (“3D”) content, according to an exemplary embodiment of the present invention;

FIG. 3e illustrates an exemplary user interface displaying a converted three-dimensional (“3D”) content, according to an exemplary embodiment of the present invention;

FIG. 4 is a flowchart illustrating a method for converting a two-dimensional (“2D”) content into a three-dimensional (“3D”) content, according to an exemplary embodiment of the present invention; and

FIG. 5 illustrates a block diagram of 2D to 3D content conversion platform, according to an exemplary embodiment of the present invention.

### DETAILED DESCRIPTION

As used in the specification and claims, the singular forms “a”, “an” and “the” may also include plural references. For example, the term “an article” may include a plurality of articles. Those with ordinary skill in the art will appreciate that the elements in the Figures are illustrated for simplicity and clarity and are not necessarily drawn to scale. For example, the dimensions of some of the elements in the Figures may be exaggerated, relative to other elements, in order to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of components, which constitutes a method and a system for converting content from two-dimensions to three-dimensions, and, particularly, the method and the system of the present invention convert dull, flat, two-dimensions images into rich, vibrant, information loaded three-dimensions images. Accordingly, the components have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising”, “having”, “containing”, and “including”, and other forms thereof, are intended to be equivalent in meaning and be open ended in that an item or items following any one of these words is not meant to be an exhaustive listing of such item or items or meant to be limited to only the listed item or items.

Techniques consistent with the present invention provide, among other features, a method and a system for converting content from two-dimensional images to three-dimensional images. Unless stated otherwise, terms such as “first” and “second” are used to arbitrarily distinguish between the elements such terms describe. Thus, these terms are not necessarily intended to indicate temporal or other prioritization of such elements. While various exemplary embodiments of the disclosed system and method have been described above it should be understood that they have been presented for purposes of example only, not limitations. It is not exhaustive and does not limit the invention to the precise form disclosed. Modifications and variations are possible in light of the above teachings or may be acquired from practicing of the invention, without departing from the breadth or scope.

Various methods and systems of the present invention will now be described with reference to the accompanying drawings which should be regarded as merely illustrative without restricting the scope and ambit of the disclosure.

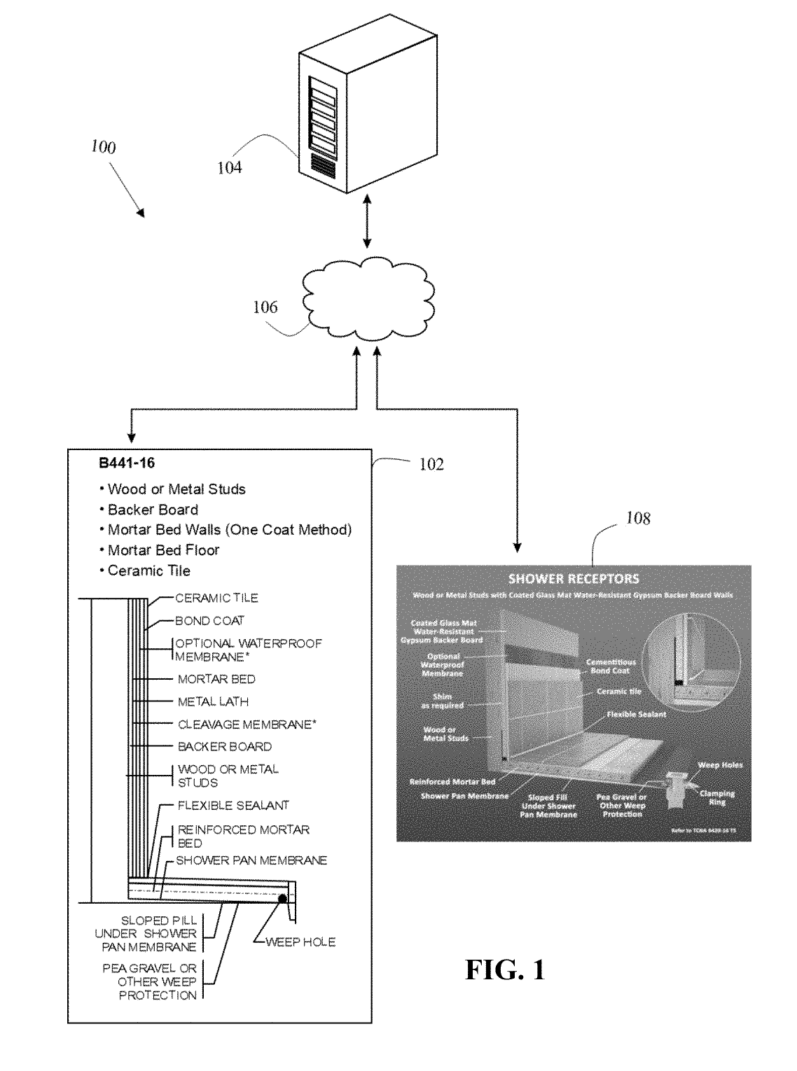

FIG. 1 illustrates a system 100 for converting a two-dimensional (“2D”) content into a three-dimensional (“3D”) content, according to an exemplary embodiment of the present invention. The system 100 includes a 2D to 3D content conversion platform 104 that receives a 2D content 102 through a network 106 and provides a 3D content 108 to a user through a communication device (not shown).

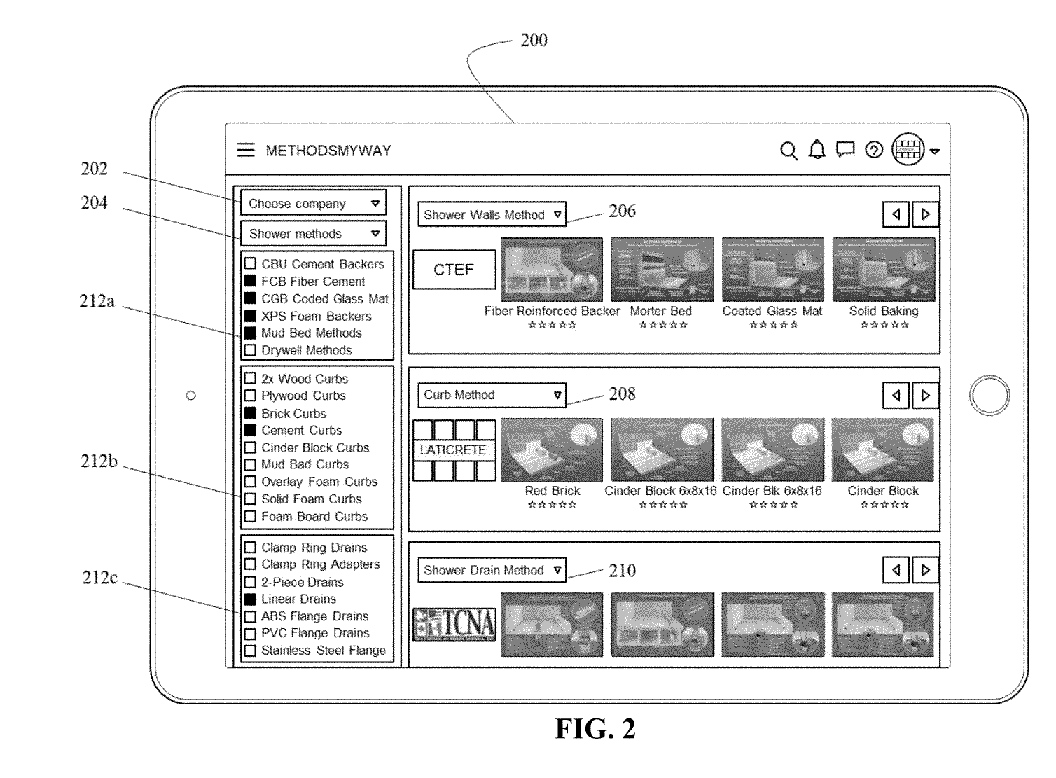

In an embodiment, the 2D to 3D content conversion platform 104 may include suitable logic, circuitry, interfaces, and/or code, executable by the circuitry, that may be configured to perform one or more operations for converting the 2D content 102 into the 3D content 108. The 2D to 3D content conversion platform 104 may be a computing device, which may include a software framework, that may be configured to create an application server implementation and perform the various operations associated with the image conversion process disclosed in the present invention. The 2D to 3D content conversion platform 104 may be realized through various web-based technologies, such as, but not limited to, a Java web-framework, a .NET framework, a PHP framework, a python framework, or any other web-application framework. Examples of the 2D to 3D content conversion platform 104 include, but are not limited to, a personal computer, a laptop, or a network of computer systems. In an embodiment, the 2D to 3D content conversion platform 104 is an application that is installed on the communication device. In another embodiment, the 2D to 3D content conversion platform 104 is a browser application. In yet another embodiment, the 2D to 3D content conversion platform 104 is a client-side application that is embedded on backend of a client portal, as shown in FIG. 2.

In context of the present invention, the communication device refers to an electronic device that can be used to communicate over the network 106. Examples of the communication device include, but are not limited to a cell phone, a smart phone, a cellular phone, a cellular mobile phone, a personal digital assistant (PDA), a wireless communication terminal, a laptop, PC, and a tablet computer.

In an embodiment, the network 106 may include suitable logic, circuitry, interfaces, and/or code, executable by the circuitry, that may be configured to transmit queries, messages, images, and requests between various entities of the system 100. In an embodiment, the network 106 includes a wired network. In another embodiment, the network 106 includes a wireless network. Examples of types of the network 106 include, but are not limited to, a local area network, a wide area network, a radio network, a virtual private network, an internet area network, a metropolitan area network, a satellite network, a wireless fidelity (Wi-Fi) network, a light fidelity (Li-Fi) network, Bluetooth Low energy, a wireless network, and a telecommunication network. Examples of the telecommunication network include, but are not be limited to, a global system for mobile communication (GSM) network, a general packet radio service (GPRS) network, third Generation Partnership Project (3GPP), an enhanced data GSM environment (EDGE), and a Universal Mobile Telecommunications System (UMTS). The present invention should not be limited in its communication nomenclature.

In an embodiment, the 2D content 102 includes at least one of an image, a Computer Aided Design (CAD) drawing, and a web image content. The 2D to 3D content conversion platform 104 receives the 2D content 102. Further, the 2D to 3D content conversion platform 104 analyzes the 2D content 102 to obtain a first set of data related to the 2D content 102. In an embodiment, the first set of data includes one or more vector parameters of one or more objects present in the 2D content 102, text related to the one or more objects present in the 2D content 102, and dimensional data of the one or more objects present in the 2D content 102. In an example, the one or more vector parameters are a line, start point (x,y,z), end point (x,y,z), and the like. In an example, an object can be a line, a circle, or any other graphic object with vector parameters. Further, text related to the one or more objects may be description of different parts of the object. In an example, as shown for shower receptors, the 2D content 102 includes text such as ceramic tile, bond coat, mortar bed, wood or metal studs, and the like. In another example, a door (generally a block) might be attached to a graphic attribute, such as an arc representing the swing of the door, and non-graphic data, such as data defining the materials of the door, or its type or model.

Further, in an embodiment, the 2D to 3D content conversion platform 104 determines a 2D-to-3D content conversion logic based on a result of the content analysis (i.e., the analysis of the 2D content 102). Further, the 2D to 3D content conversion platform 104 generates the 3D content 108 by applying the determined logic to the received 2D content 102. To accurately convert a 2D drawing (i.e., the 2D content 102) into a 3D model (i.e., the 3D content 108), the coordinates of the 2D drawing is converted into their corresponding 3D coordinates. This allows the 2D to 3D content conversion platform 104 to build the 3D model with the proper drawing relationships and locations in a 3D space. The 2D drawing comprises a collection of points along an XY axis, wherein every point in a drawing corresponds to a value on the X-axis, and a value on the Y-axis. The XY value is considered to be coordinate, or location of a point. Conversion of a point from a 2D drawing space into a 3D physical space involves translational, rotational, and scale transformations of the coordinates. To convert a point in the 2D drawing space into a point in the 3D physical space, the following information may be typically required:
1. Coordinates of any three non-collinear points (control points) lying in a drawing plane, in which the points are represented in both:
   a) the 3D global physical system; and
   b) the 2D drawing system.
2. Coordinates in the 2D drawing space of the point for conversion.
   Information in the 2D content 102 above defines the relative orientation, position, and scale of the two systems (the 2D drawing and 3D physical spaces) with respect to each other. Information in the 2D content 102 defines the local coordinates, or location, in the 2D drawing of the point to be converted. Different scales along the two axes of the 2D drawing space are automatically accounted. In general, the scale in the X and Y direction of a 2D drawing are the same. However, frames that are slightly inclined in a vertical plane are usually drawn by projecting onto the vertical plane. In that case, the drawing has different scales in the two directions of the drawing (X and Y). The disclosed procedure accounts for the possibility of different scales for the X and Y axes.

After generating the 3D content 108, the 2D to 3D content conversion platform 104 provides the generated 3D content 108 to the user through the communication device. For example, the 2D to 3D content conversion platform 104 may be configured to render a graphical user interface (GUI) on the communication device of the user and present the generated 3D content 108 to the user via the network 106. The user can browse though the GUI by means of one or more selectable options presented on the GUI to extract and view the desired result, for example, the 3D content 108.

FIG. 2 illustrates an exemplary user interface 200 of the system that facilitates the user to search the 3D content 108 corresponding to the 2D content 102 based on one or more user preferences selected by the user, according to an exemplary embodiment of the present invention. The 2D to 3D content conversion platform 104 is embedded on the backend of the user interface 200. In an embodiment, the user can access the client portal as a registered user. Thus, prior to the usage of the client portal, the user must register with the client portal by providing the requisite details such as name, age, email, contact number, address, and the like, and thereby creating a user identifier (ID) and a password. The user may utilize the user ID and the password to log-in into the client portal. In another embodiment, the user can access the client portal as a guest user in which the user may not be required to log-in into the client portal using the user ID and the password. If the user is the registered user, the user can save his/her portfolio or browsing interaction in a user profile.

In an embodiment, the user interface 200 includes one or more selectable options (i.e., 2D or 3D buttons, tabs, drop-down menus) such as a drop-down menu 202, a drop-down menu 204, a drop-down menu 206, a drop-down menu 208, and a drop-down menu 210. The user interface 200 further includes one or more sections, such a section 212a, a section 212b, and a section 212c, that are configured onto left side of the user interface 200. Each section includes one or more configurable items that can be selected by the user to configure the display of the 3D content 108. In an embodiment, the user interface 200 facilitates the user to search the 3D content 108 corresponding to the 2D content 102 based on one or more user preferences selected by the user. The user can provide the one or more user preferences by selecting or inputting relevant content associated with the one or more selectable options (such as the drop-down menu 202, the drop-down menu 204, the drop-down menu 206, the drop-down menu 208, and the drop-down menu 210) and the one or more sections (such the section 212a, the section 212b, and the section 212c).

In an embodiment, the user can choose an entity name (e.g., a company name) though the drop-down menu 202, as shown in FIG. 2. Similarly, the user can choose a method name though the drop-down menu 204. For example, when the user chooses the shower method from the drop-down menu 204, then different shower methods (i.e., a shower wall method shown in the drop-down menu 206, a curb method shown in the drop-down menu 208, a shower drain method shown in the drop-down menu 210, or the like) are displayed on the user interface 200. Further, the user can select different material for each shower method and corresponding result is shown in various ways (e.g., tiles, mosaic, zoomed, and the like). For example, the user can select “linear drains” from the section 212c configured onto the left side of the user interface 200, then the corresponding result (e.g., hydro ban linear, kerdi drain adapter, kardi drain, and motar bed) is displayed. The user can select any of the 3D content from the result to visualize the method in an informative way.

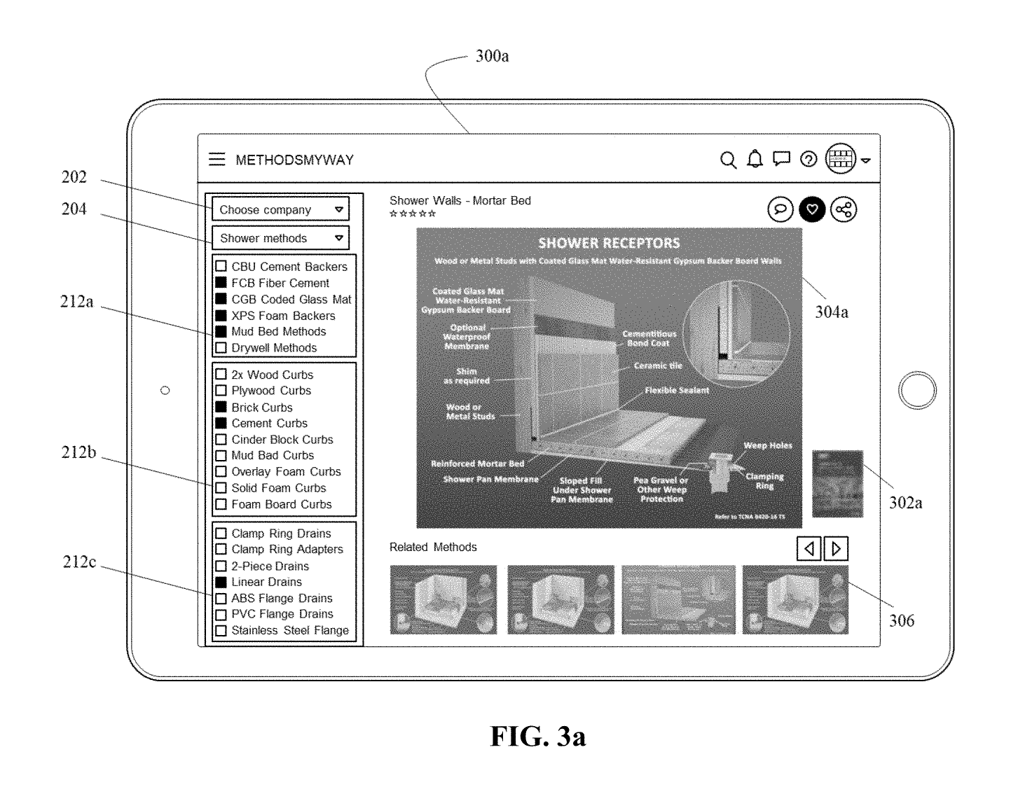

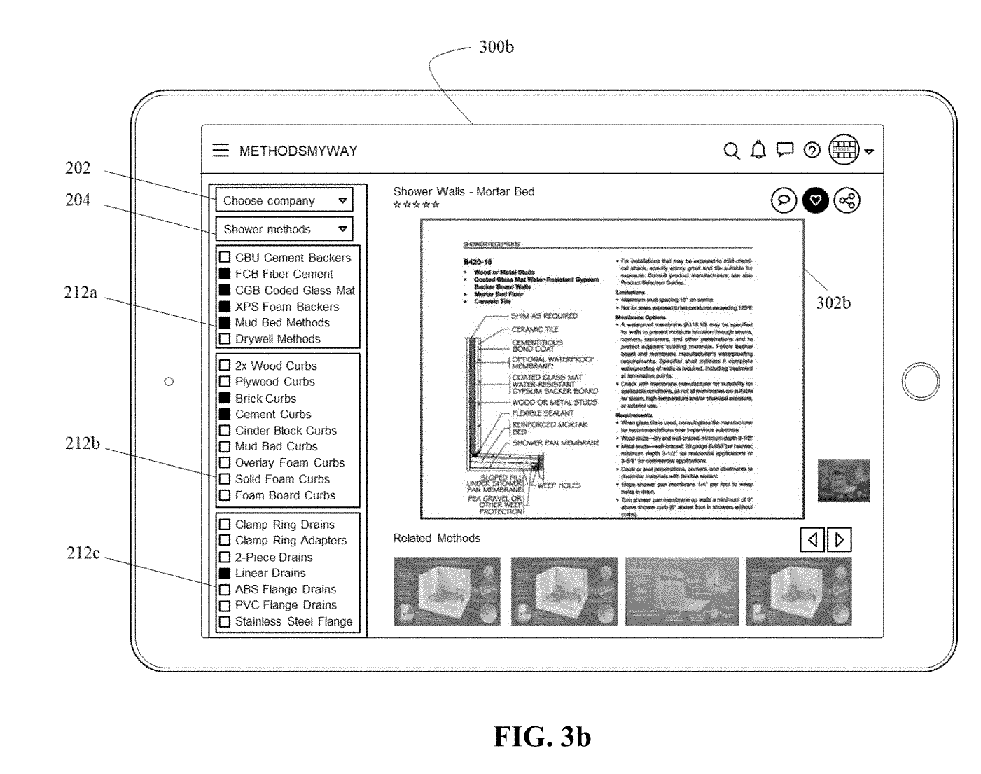

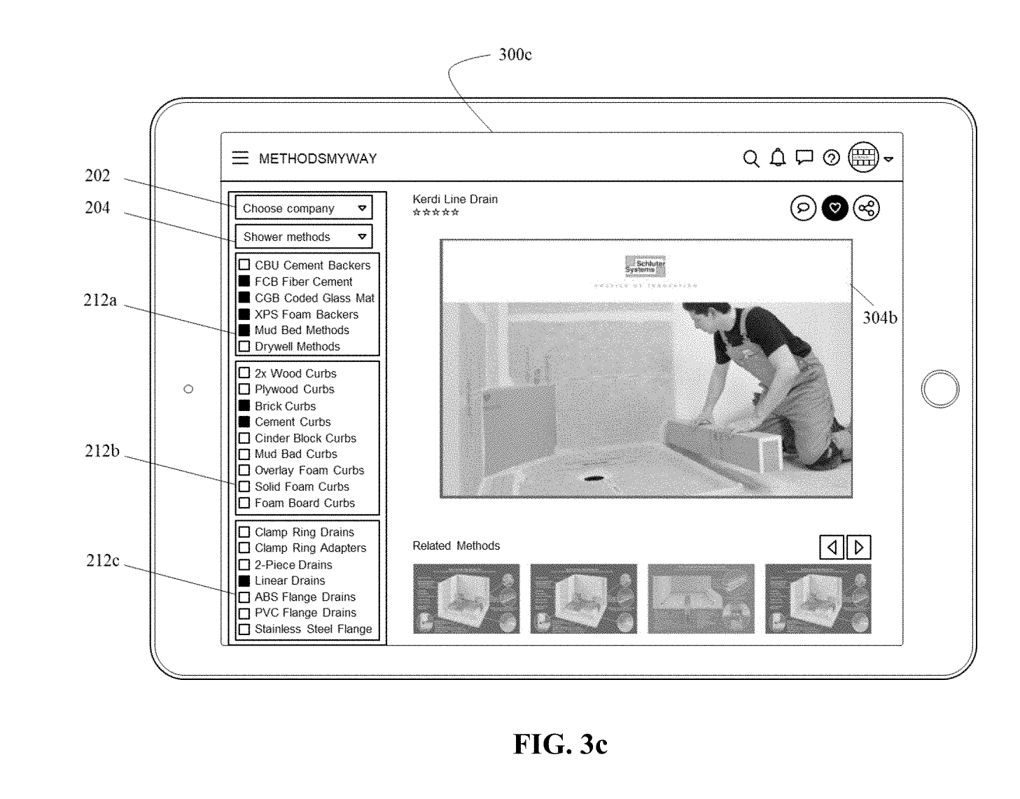

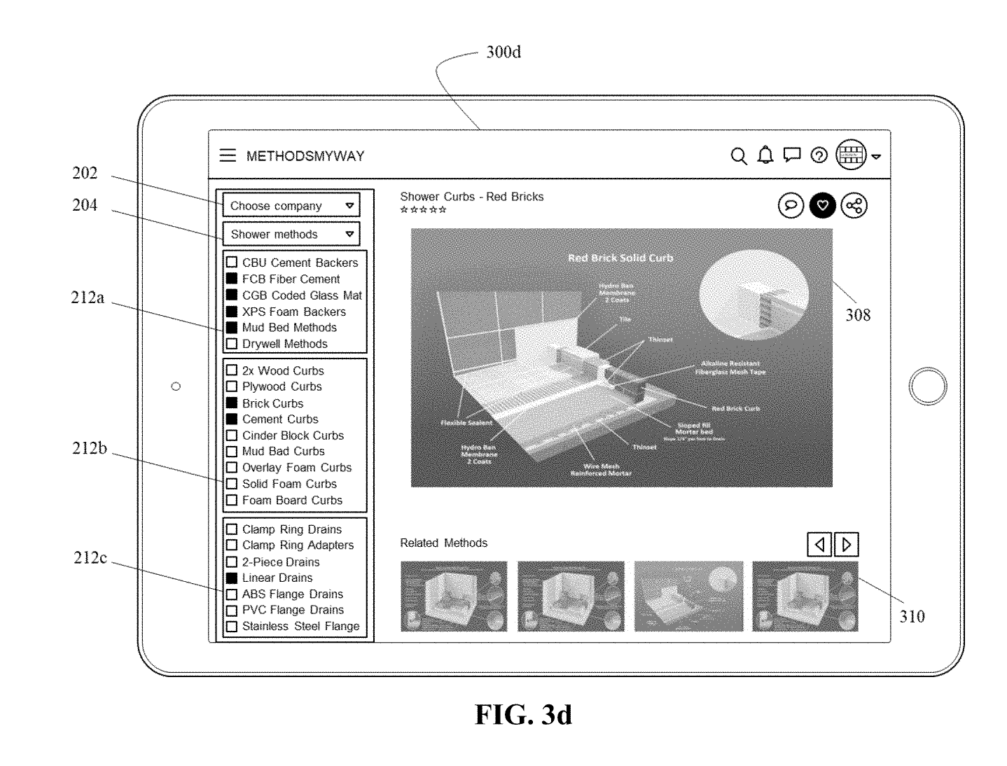

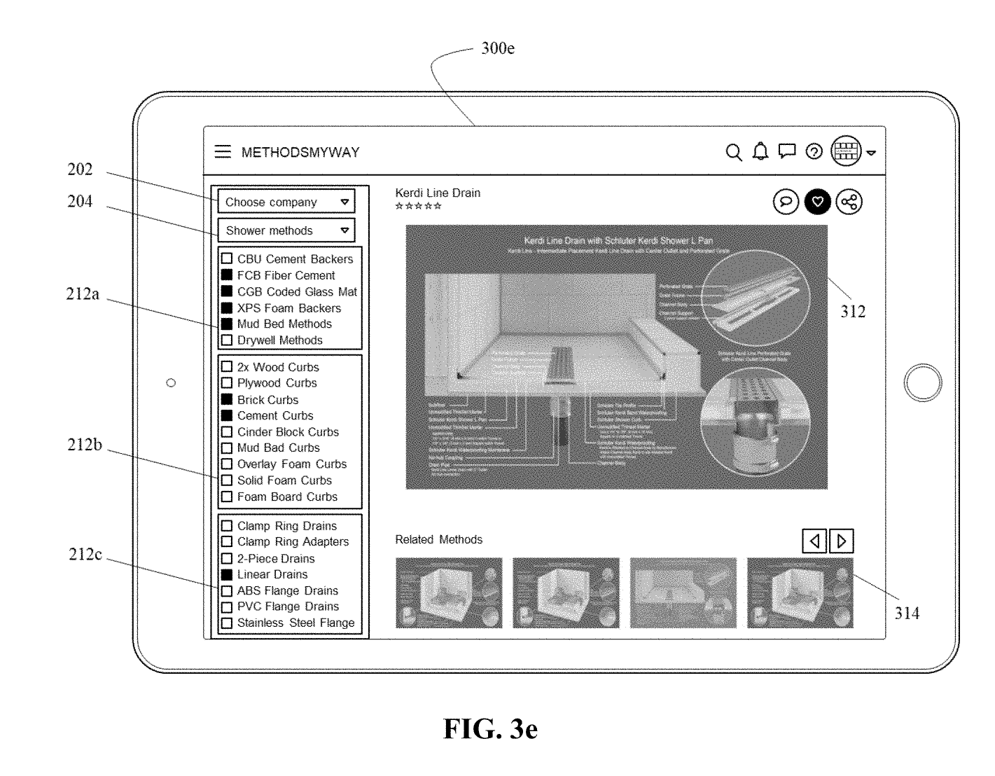

FIGS. 3a-3c illustrates an exemplary scenario where a 2D content 302a is converted to a 3D content 304a, according to an exemplary embodiment of the present invention. The 2D to 3D content conversion platform 104 is embedded on the backend of the client-portal. The 2D to 3D content conversion platform 104 receives the 2D content 302a, analyzes the 2D content 302a to obtain a first set of data related to the 2D content 302a, determines a 2D-to-3D content conversion logic based on a result of the content analysis, and generates the 3D content 304a by applying the determined logic to the received 2D content 302a. The generated 3D content or images may be displayed as tiles (Icons) 306 on the user interface 300a of the client-portal. In an embodiment, the 2D content 302a is a Portable Document Format (PDF) document 302b, as shown on the user interface 300b of FIG. 3b. However, it is possible that other formats of documents may be used instead of the PDF document 302b, without limiting the scope of the present invention. The PDF document 302b contains 2D images related to the method and detail description about the method. The 2D to 3D content conversion platform 104 converts the dull, flat, 2D images present in the PDF document 302b into rich, vibrant, information loaded 3D content 306. Further, the 3D content 306 is more informative as shown in FIG. 3c, for example, the 3D content 304b displayed on the user interface 300c.

FIG. 3d illustrates an exemplary user interface 300d displaying a converted 3D content 308, according to an exemplary embodiment of the present invention. In an embodiment, the user can choose a company name though the drop-down menu 202.

Similarly, the user can choose a method name though the drop-down menu 204. For example, when the user chooses the shower method from the drop-down menu 204, then different shower methods (i.e., a shower wall method shown in the drop-down menu 206, a curb method shown in the drop-down menu 208, a shower drain method shown in the drop-down menu 210, or the like) are displayed (for example, as shown on the user interface 200 of FIG. 2). Further, when the user chooses the shower curb method from the drop-down menu 208, then different shower curb methods such as the 3D content 308 is displayed on the user interface 300d. Various other 3D content of the related shower curb methods are displayed as tiles 310. The user can also select different material for the shower curb method and corresponding result is shown in various ways (e.g., tiles, mosaic, zoomed, and the like). For example, the user can select “FCB Fiber Cement”, “CGB Coded Glass Mat”, “XPS Foam Backers”, and “Mud Bed Methods” from the section 212a. Similarly, the user can select “Brick Curbs” and “Cement Curbs” from the section 212b and “linear drains” from the section 212c, then the corresponding results (such as the 3D content 308 and the related 3D content 310) are displayed. The user can select any of the 3D content from the result to visualize the method in an informative way.

FIG. 3e illustrates an exemplary user interface 300e displaying a converted 3D content 312, according to an exemplary embodiment of the present invention. In an embodiment, the user can choose a company name though the drop-down menu 202. Similarly, the user can choose a method name though the drop-down menu 204. For example, when the user chooses the shower method from the drop-down menu 204, then different shower methods (i.e., a shower wall method shown in the drop-down menu 206, a curb method shown in the drop-down menu 208, a shower drain method shown in the drop-down menu 210, or the like) are displayed (for example, as shown on the user interface 200 of FIG. 2). Further, when the user chooses the shower drain method shown in the drop-down menu 210, then different shower drain methods such as the 3D content 312 is displayed on the user interface 300e. Various other 3D content of the related shower drain methods are displayed as tiles 314. The user can also select different material for the shower curb method and corresponding result is shown in various ways (e.g., tiles, mosaic, zoomed, and the like). For example, the user can select “FCB Fiber Cement”, “CGB Coded Glass Mat”, “XPS Foam Backers”, and “Mud Bed Methods” from the section 212a. Similarly, the user can select “Brick Curbs” and “Cement Curbs” from the section 212b and “linear drains” from the section 212c, then the corresponding results (such as the 3D content 312 and the related 3D content 314) are displayed. The user can select any of the 3D content from the result to visualize the method in an informative way.

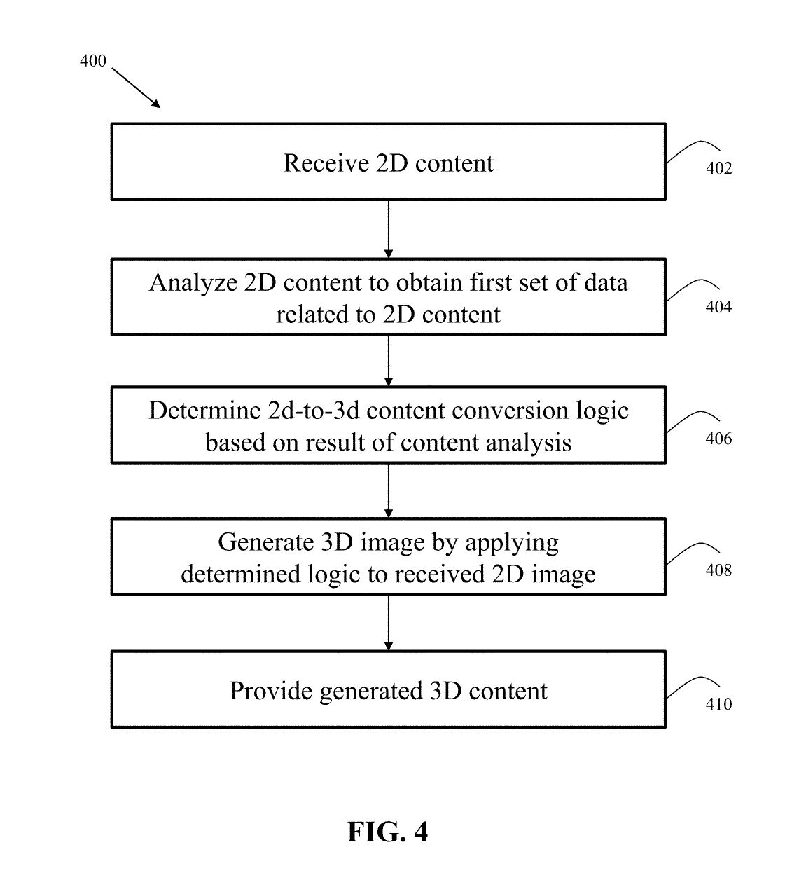

FIG. 4 is a flowchart 400 illustrating a method for converting the 2D content 102 into the 3D content 108, according to an exemplary embodiment of the present invention. At step 402, the method includes receiving the 2D content 102. In an embodiment, the 2D content 102 includes at least one of an image, a CAD drawing, and a web image content. The image can come from one or more viewable sources. The one or more viewable sources include papers, pictures, portable document formats (“pdfs”), portable network graphics (“pngs), photoshop documents (“psds”), CAD, or the like. In an embodiment, the method allows the 2D to 3D content conversion platform 104 to receive the 2D content 102.

At step 404, the method includes analyzing the 2D content 102 to obtain the first set of data related to the 2D content 102. The method allows the 2D to 3D content conversion platform 104 to analyze the 2D content 102 to obtain the first set of data related to the 2D content 102. The first set of data includes the one or more vector parameters of the one or more objects present in the 2D content 102, the text related to the one or more objects present in the 2D content 102, and the dimensional data of the one or more objects present in the 2D content 102.

At step 406, the method includes determining the 2D-to-3D content conversion logic based on a result of the content analysis. The method allows the 2D to 3D content conversion platform 104 to determine the 2D-to-3D content conversion logic based on the result of the content analysis.

At step 408, the method includes generating the 3D content 108 by applying the determined logic to the received 2D content 102. The method allows the 2D to 3D content conversion platform 104 to generate the 3D content 108 by applying the determined logic to the received 2D content 102.

At step 410, the method includes providing the generated 3D content 108. The method allows the 2D to 3D content conversion platform 104 to provide the generated 3D content 108. In an embodiment, the 2D to 3D content conversion platform 104 may render one or more GUIs on the communication device of the user to present the generated 3D content 108. Each GUI (such as the user interfaces 300a-300e) may present the generated 3D content 108 along with the related 3D content. Further, each GUI may provide the one or more selectable options to the user. The user can provide one or more inputs, such as touch-based inputs, voice-based inputs, gesture-based inputs, or the like, to select the one or more selectable options for configuring the generated 3D content 108 as per the user's preferences.

The various actions, acts, blocks, steps, or the like in the flow diagram may be performed in the order presented, in a different order or simultaneously. Further, in some embodiments, some of the actions, acts, blocks, steps, or the like may be omitted, added, modified, skipped, or the like without departing from the scope of the present invention.

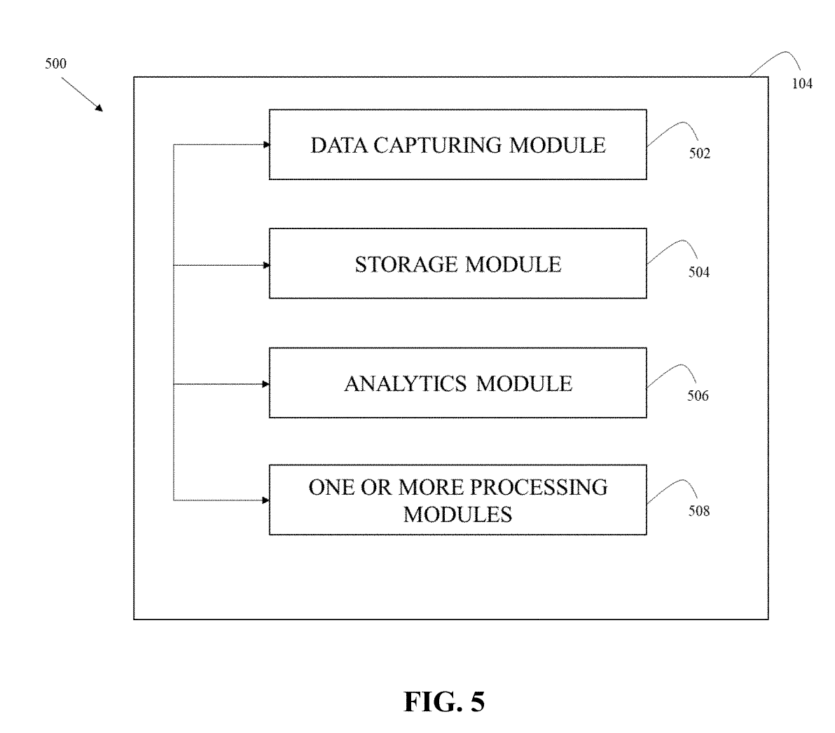

FIG. 5 illustrates a block diagram 500 of the 2D to 3D content conversion platform 104, according to an exemplary embodiment of the present invention. In an embodiment, the 2D to 3D content conversion platform 104 includes a data capturing module 502, a storage module 504, an analytics module 506, and one or more processing modules 508.

The data capturing module 502 may include suitable logic, circuitry, interfaces, and/or codes, executable by the circuitry, that may be configured to perform one or more operations. In an embodiment, the data capturing module 502 is configured to receive the 2D content 102. Further, the data capturing module 502 is configured to analyze the 2D content 102 to obtain the first set of data related to the 2D content 102. Examples of the data capturing module 502 include, but are not limited to, an application-specific integrated circuit (ASIC) processor, a reduced instruction set computing (RISC) processor, a complex instruction set computing (CISC) processor, or a field-programmable gate array (FPGA).

The storage module 504 may include suitable logic, circuitry, interfaces, and/or codes, executable by the circuitry, that may be configured to perform one or more operations. In an embodiment, the storage module 504 is configured to store the 2D content 102 and the first set of data related to the 2D content 102. In an embodiment, the storage module 504 is a multi-tier storage system. In another embodiment, the storage module 504 stores the information in an encrypted format. In yet another embodiment, the storage module 504 stores the information in an indexed format. The storage module 504 facilitates storage, retrieval, modification, and deletion of data in conjunction with various data-processing operations. Storage module information may be retrieved through queries using keywords and sorting commands, and various algorithm in order to rapidly search, rearrange, group, and select the field.

In one embodiment, the storage module 504 is secure web servers and Hypertext Transport Protocol Secure (HTTPS) capable of supporting Transport Layer Security (TLS). Communications to and from the secure web servers may be secured using Secure Sockets Layer (SSL). An SSL session may be started by sending a request to the Web server with an HTTPS prefix in the URL. Alternatively, any known communication protocols that enable devices within a computer network to exchange information may be used. Examples of protocols are as follows: IP (Internet Protocol), UDP (User Datagram Protocol), TCP (Transmission Control Protocol), DHCP (Dynamic Host Configuration Protocol), HTTP (Hypertext Transfer Protocol), FTP (File Transfer Protocol), Telnet (Telnet Remote Protocol), SSH (Secure Shell Remote Protocol), POP3 (Post Office Protocol 3), SMTP (Simple Mail Transfer Protocol), IMAP (Internet Message Access Protocol), SOAP (Simple Object Access Protocol), PPP (Point-to-Point Protocol), RFB (Remote Frame buffer) Protocol.

The analytics module 506 may include suitable logic, circuitry, interfaces, and/or codes, executable by the circuitry, that may be configured to perform one or more operations. In an embodiment, the analytics module 506 is configured to determine the 2D-to-3D content conversion logic based on the result of the content analysis and generate the 3D content 108 by applying the determined logic to the received 2D content 102. The analytics module 506 may be implemented by one or more processors, such as, but are not limited to, an ASIC processor, a RISC processor, a CISC processor, and an FPGA.

Each of the one or more processing modules 508 may include suitable logic, circuitry, interfaces, and/or codes, executable by the circuitry, that may be configured to perform one or more operations. The one or more processing modules 508 are configured to process data related to the 2D content 102. The one or more processing modules 508 are associated with a memory module (not shown). The memory module is accessible by the one or more processing modules 508 to receive and store the data. The memory module may be a main memory, such as a high-speed Random-Access Memory (RAM), or an auxiliary storage unit, such as a hard disk, a floppy disk, or a magnetic tape drive. The memory may be any other type of memory, such as a Read-Only Memory (ROM), or optical storage media such as a videodisc and a compact disc. The one or more processing modules 508 may access the memory module to retrieve the data. Examples of one or more processing modules include, but are not limited to, a central processing unit (CPU), a front-end processor, a microprocessor, a graphics processing unit (GPUNPU), a physics processing unit (PPU), a digital signal processor, and a network processor.

It will finally be understood that the disclosed embodiments are presently preferred examples of how to make and use the claimed invention, and are intended to be explanatory rather than limiting of the scope of the present invention as defined by the claims below. Reasonable variations and modifications of the illustrated examples in the foregoing written specification and drawings are possible without departing from the scope of the present invention as defined in the claim below. It should further be understood that to the extent the term “invention” is used in the written specification, it is not to be construed as a limited term as to number of claimed or disclosed inventions or the scope of any such invention, but as a term which has long been conveniently and widely used to describe new and useful improvements in technology The scope of the invention supported by the above disclosure should accordingly be construed within the scope of what it teaches and suggests to those skilled in the art, and within the scope of any claims that the above disclosure supports. The scope of the invention is accordingly defined by the following claims.

Although particular embodiments of the present invention have been described in detail for purposes of illustration, various modifications and enhancements may be made without departing from the spirit and scope of the invention.

What is claimed is:

1. A content conversion method, comprising:
receiving two-dimensional (“2D”) content;
analyzing the 2D content to obtain a first set of data related to the 2D content;
determining a 2D-to-3D content conversion logic based on the analysis of 2D content;
generating three-dimensional (“3D”) content by applying the determined 2D-to-3D content conversion logic to the received 2D content; and
rendering a user interface on a communication device of a user to present the generated 3D content.

2. The content conversion method of claim 1, wherein the 2D content comprises at least one of an image, a Computer Aided Design (CAD) drawing, or a web image content.

3. The content conversion method of claim 2, wherein the image is obtained from one or more viewable sources, and wherein the one or more viewable sources include papers, pictures, portable document formats (“pdfs), portable network graphics (“pngs), photoshop documents (“psds”), or CAD.

4. The content conversion method of claim 1, wherein the first set of data comprises one or more vector parameters of one or more objects present in the 2D content, text related to the one or more objects present in the 2D content, and dimensional data of the one or more objects present in the 2D content.

5. The content conversion method of claim 4, wherein a vector parameter corresponds to at least one of a line, a start point, or an end point, wherein an object corresponds to at least one of a line, a circle, or a graphic object, and the text of the object corresponds to description of different parts of the object.

6. The content conversion method of claim 1, wherein the user interface includes a first drop-down menu and a second drop-down menu, wherein the first drop-down menu facilitates selection of an entity name, and wherein the second drop-down menu facilitates selection of a method name.

7. The content conversion method of claim 6, wherein the user interface further includes one or more sections including one or more configurable items that are selectable by the user to configure display of the generated 3D content on the user interface.

8. The content conversion method of claim 7, wherein the first drop-down menu, the second drop-down menu, and the one or more sections are included on at least left side of the user interface.

9. The content conversion method of claim 1, further comprising converting coordinates of the 2D content into corresponding 3D coordinates to accurately convert the 2D content into a 3D model.

10. A content conversion system, comprising:
circuitry configured to:
receive two-dimensional (“2D”) content;
analyze the 2D content to obtain a first set of data related to the 2D content;
determine a 2D-to-3D content conversion logic based on the analysis of 2D content;
generate three-dimensional (“3D”) content by applying the determined 2D-to-3D content conversion logic to the received 2D content; and
render a user interface on a communication device of a user to present the generated 3D content.

11. The content conversion system of claim 10, wherein the 2D content comprises at least one of an image, a Computer Aided Design (CAD) drawing, or a web image content.

12. The content conversion system of claim 10, wherein the first set of data comprises one or more vector parameters of one or more objects present in the 2D content, text related to the one or more objects present in the 2D content, and dimensional data of the one or more objects present in the 2D content.

13. The content conversion system of claim 10, wherein the user interface includes a first drop-down menu and a second drop-down menu, wherein the first drop-down menu facilitates selection of an entity name, and wherein the second drop-down menu facilitates selection of a method name.

14. The content conversion system of claim 13, wherein the user interface further includes one or more sections including one or more configurable items that are selectable by the user to configure display of the generated 3D content on the user interface.

15. The content conversion system of claim 10, wherein the circuitry is further configured to convert coordinates of the 2D content into corresponding 3D coordinates to accurately convert the 2D content into a 3D model.

16. A two-dimensional (“2D”) to three-dimensional (“3D”) content conversion platform, comprising:
circuitry configured to:
receive 2D content;
analyze the 2D content to obtain a first set of data related to the 2D content;
determine a 2D-to-3D content conversion logic based on the analysis of 2D content;
generate 3D content by applying the determined 2D-to-3D content conversion logic to the received 2D content; and
render a user interface on a communication device of a user to present the generated 3D content.

17. The 2D to 3D content conversion platform of claim 16, wherein the 2D content comprises at least one of an image, a Computer Aided Design (CAD) drawing, or a web image content.

18. The 2D to 3D content conversion platform of claim 16, wherein the first set of data comprises one or more vector parameters of one or more objects present in the 2D content, text related to the one or more objects present in the 2D content, and dimensional data of the one or more objects present in the 2D content.

19. The 2D to 3D content conversion platform of claim 16, wherein the user interface includes a first drop-down menu and a second drop-down menu, wherein the first drop-down menu facilitates selection of an entity name, and wherein the second drop-down menu facilitates selection of a method name.

20. The 2D to 3D content conversion platform of claim 16, wherein the circuitry is further configured to convert coordinates of the 2D content into corresponding 3D coordinates to accurately convert the 2D content into a 3D model.
